(19) United States
(12) Patent Application Publication
(10) Pub. No.: US 2023/0092309 A1
(43) Pub. Date: Mar. 23, 2023

(54) NANOEMULSION, PLANT-BASED MEAT AND PREPARATION METHOD THEREOF

(71) Applicants: Chui Chui CHEUNG, HONG KONG (HK); Plant A Foods Hong Kong Limited, Hong Kong (HK)

(72) Inventors: Chui Chui CHEUNG, Hong Kong (HK); Mabel Wai Ling LEE, Hong Kong (HK); Cheuk Ying WONG, Hong Kong (HK)

(21) Appl. No.: 17/454,619

(22) Filed: Nov. 11, 2021

(30) Foreign Application Priority Data
Sep. 18, 2021 (HK) 32021039110.0

(51) Int. Cl. A23D 7/005; A23L 29/10; A23J 3/16; A23L 27/00; A23L 29/20; A23L 35/00

(52) U.S. Cl. CPC A23D 7/0053; A23J 3/16; A23L 27/80; A23L 29/10; A23L 29/20; A23L 35/10

(57) ABSTRACT

The invention provides nanoemulsion for preparing plant-based meat, the nanoemulsion has a particle size ranging from 300 nm to 320 nm. The plant-based meat prepared by using the nanoemulsion of the present invention can retain flavors after various cooking methods. The plant-based meat of the present invention can withstand different pH values and temperatures, and remains stable at different concentrations of salt, sugar, lipids, protein, carbohydrates and a variety of organic compounds, and will not lower consumer’s flavor expectations and perceptions. The plant-based meat of the present invention retains more flavors, so less flavoring is needed, and the cost will be reduced.

### CROSS-REFERENCE TO RELATED APPLICATIONS

This application claims priority to HONG KONG Patent Application No. 32021039110.0 with a filing date of Sep. 18th, 2020. The content of the aforementioned application, including any intervening amendments thereto, are incorporated herein by reference.

### FIELD OF THE INVENTION

The invention relates to the field of food, in particularly nanoemulsion, plant-based meat and a preparation method thereof.

### BACKGROUND OF THE INVENTION

Plant-based meat (Plant meat) refers to food products made from plant-based raw materials that imitate the flavor, taste or appearance of animal meat, and extra spices are usually added to increase the similarity between plant-based products and real meat products. In recent years, the research and products of plant meat have been continuously updated. There are mainly two types on the market: one is a single piece of protein plant meat obtained by dry extrusion; the other is a protein plant meat recombined after breaking the protein’s tissue. However, in the cooking process, the flavors and aroma of plant meat are easily lost due to dissolution, evaporation or chemical degradation. Therefore, plant meat products on the market are not suitable for some cooking methods that require long boiling. To retain the flavors, plant-based meat can only be heated for a short duration. Therefore, there is an urgent need to find a plant meat suitable for long cooking duration.

### SUMMARY OF INVENTION

The invention relates to nanoemulsion for preparing plant-based meat, the nanoemulsion has a particle size ranging from 300 nm to 320 nm. The plant-based meat prepared by using the nanoemulsion of the present invention can retain flavors after various cooking methods. The plant-based meat of the present invention can withstand different pH values and temperatures, and remains stable at different concentrations of salt, sugar, lipids, protein, carbohydrates and a variety of organic compounds, and will not lower consumer’s flavor expectations and perceptions. The plant-based meat of the present invention retains more flavors, so less flavoring is needed, and the cost will be reduced.

Specifically, in one aspect, the present invention provides nanoemulsion for preparing plant-based meat, wherein the nanoemulsion has a particle size ranging from 300 nm to 320 nm.

In some embodiments, wherein the nanoemulsion is prepared through high-pressure homogenization using oil and water in a certain proportion.

Wherein the high-pressure is not lower than 30 MPa.

In some embodiments, wherein the oil has a volume percentage ranging from 30% to 70%, and the water has a volume percentage ranging from 30% to 70%.

In some embodiments, wherein the oil is a long-chain triglyceride.

The percentage of the long-chain triglycerides in the oil described herein may be 100%, more than 90%, more than 80%, more than 70% or more than 60%.

In some embodiments, wherein the oil is sunflower oil, canola oil, corn oil, soybean oil, macadamia oil, olive, safflower oil or a combination thereof.

In other aspect, the present invention also provides plant-based meat, wherein the plant-based meat is prepared by mixing the nanoemulsion described herein with dry particles, wherein the dry particles include plant-based protein, non-starch polysaccharides and hydrocolloids, and wherein the plant-based protein has a particle size ranging from 90 µm to 230 µm, the hydrocolloid has a particle size ranging from 2 µm to 150 µm.

In some embodiments, wherein the plant-based protein is prepared from soybeans, peas, mung beans or broad beans; wherein the non-starch polysaccharides are inulin, cellulose, pectin or glucan; and wherein the hydrocolloids are xanthan gum, carrageenan, guar gum, locust bean gum or konjac.

In other aspect, the present invention provides a method of preparing the plant-based meat described herein, comprising of the following steps:
(1) mix the nanoemulsion from the present invention with dry particles;
(2) refrigerate the mixture from step (1) for at least one hour and mix in the plant-based meat.

After the oil and water has been emulsified, the dry particles are mixed in. The blending step increases the homogeneity of each component. Reactions between fatty acid chains contribute to aroma distribution and the way the flavor intensity is perceived. The dry particles include polysaccharides and proteins. Polysaccharides act as a thickening agent, emulsifier, and emulsion stabilizer. The viscosity change aids in flavor perception and release. The protein helps to retain flavor by binding and interacting with the flavoring’s aroma compounds and trapping them in its binding sites. It also decreases the interfacial tension, which decreases the likelihood of phase separation.

Blending is followed by a cooling step. Reduction of temperature lowers the kinetic energy of the particles. Then, the nanoemulsion product solidifies and enhances the overall sensory profile of plant-based food. Fewer flavors are needed in plant-based products.

In other aspect, the present provides use of the nanoemulsion described herein in preparing the plant-based meat.

### DETAILS AND DEFINITIONS

Unless otherwise defined, the terms used in the specification and claims have the following definitions, the invention covers all alternatives, modifications and equivalents, they are all included in the scope of the present invention as defined by the claims. One skilled in the relevant art will recognize that many methods and materials similar or equivalent to those described herein can be used to practice the present invention. The invention is by no means limited to the methods and materials described herein. In the case where one or more of the combined documents, patents and similar materials are different from or contradictory to this invention (including but not limited to the defined terms, term application, described technology, etc.), subject to this invention.

It should further be observed that some features of the present invention have been described in multiple independent embodiments for clarity, but may also be provided in combination in a single embodiment. Conversely, the various features of the present invention are described in a single embodiment for the sake of brevity, but they can also be provided individually or in any suitable sub-combination.

Unless otherwise specified, all scientific and technological terms used in the present invention have the same meanings as commonly understood by those skilled in the art to which the present invention belongs. All patents and publications related to the present invention are incorporated into the present invention in their entirety by reference.

The nanoemulsion described herein is a water-in-oil emulsion prepared through a homogenization process.

The plant-based protein of the present invention is a kind of protein, which is derived from plants, has comprehensive nutrition, is like animal protein, is easily digested and absorbed by the human body, and has a variety of physiological health functions. Sources include but are not limited to soybeans, wheat (flour) and rice. Non-limiting examples of the plant-based protein of the present invention are prepared from soybeans, peas, mung beans, and broad beans.

The non-starch polysaccharide in the present invention refers to polysaccharides other than starch such as cellulose, hemicellulose, pectin, etc., which are the main components of dietary fiber. Dietary fiber is a kind of complex carbohydrate. Non-limiting examples of the non-starch polysaccharides of the present invention are inulin, cellulose, pectin, and dextran.

The hydrocolloid of the present invention includes a large group of polysaccharides and proteins, which dissolves in water as a colloid and exhibits a high ability to form a gel. Non-limiting examples of the hydrocolloid of the present invention are xanthan gum, carrageenan, guar gum, mung bean gum, locust bean gum or konjac.

The long-chain triglycerides (LCT) of the present invention include but are not limited to sunflower oil, rapeseed oil, corn oil, soybean oil, macadamia oil, olive oil, and safflower oil or any combination thereof.

The dry particles of the present invention include plant-based protein, non-starch polysaccharides and hydrocolloids. It can be prepared by cleaning, peeling, slicing, drying, grinding and other processes.

### DESCRIPTION OF DRAWINGS

FIG. 1 shows the differences between salinities’ change of water boiling with the plant-based meatballs (with and without nanoemulsion) at different temperatures over 30 minutes.

FIG. 2 shows the differences between Brix % change of water boiling with the plant-based meatballs (with and without nanoemulsion) at different temperatures over 30 minutes.

FIG. 3 shows the differences between pH change of water boiling with the plant-based meatballs (with and without nanoemulsion) at different temperatures over 30 minutes.

FIG. 4 shows the improvement in flavor retention between the plant-based meatball with and without the nanoemulsion is 37% and 27% respectively. Additionally there is 83% and 78% flavor retention improvement in terms of brix% and salinity with different particle sizes.

FIG. 5 shows the color change of the water boiled with 60 g meatball over 30 minutes at 3 minute intervals. Group T is the group without nanoemulsion, and group B is the group with nanoemulsion; L-R 0-15 min, which means sampling starts from left to right at 3 minute intervals from 0-15 minutes; L-R 18-30 min, which means that samples are taken sequentially every 3 minutes from 18-30 minutes from left to right.

### EXAMPLES

To make the purpose, technical scheme and advantages of the present invention clearer and more obvious, the present invention will be further illustrated in detail in combination with accompanying embodiments hereinafter. It should be understood that the specific embodiments described here are only used to explain the present invention, but not used to limit the present invention. Based on the embodiments of the present invention, all other embodiments obtained by those of ordinary skill in the art without creative work shall fall within the protection scope of the present invention. In addition, the technical features involved in the different embodiments of the present invention described below can be combined with each other as long as they do not conflict with each other.

### Examples

### Preparation

The oil and water for preparing plant-based meat (in this example, the volume ratio of oil to water is 40:60; in other embodiments, water: 30-70%, oil: 30-70%) are added to a high-pressure Homogenizer (HPH) in a certain proportion, and the mixture is homogenized under no less than 30 MPa to form a nanoemulsion with a particle size ranging from 300 nm to 320 nm.

Wherein rapeseed oil is selected as the oil. In other embodiments, the oil may be sunflower seed oil, corn oil, soybean oil, unsaturated fatty acid, or plant meat flavor essences rich in long-chain triglycerides (LCT).

The nanoemulsion is mixed well with dry particles and is refrigerated for at least 1 hour to produce plant-based meat. The temperature during mixing depends on the gelling temperature of the hydrocolloid, generally 60-90° C.

The dry particles are composed of plant protein, non-starch polysaccharides and hydrocolloids. The particle size of the protein ranges from 90 µm to 230 µm, and the hydrocolloid ranges from 2 µm to 150 µm.The plant protein can be prepared from soybeans, peas, mung beans, and broad beans, which can be prepared through conventional procedures such as cleaning, peeling, slicing, drying, and grinding.

Wherein the hydrocolloids can be selected:

Hydrocolloids variety #1: passes through a 100 mesh and has a size of around 149 µm. The apparent viscosity is between 40000 cps and 60000 cps in 2% solution at 20° C. The gelling temperature is between 50° C. and 55° C.

Hydrocolloids variety #2: passes through a 120 mesh and has a size of around 125 µm. The viscosity is at least 33,000 MPas in 1% aqueous solution at 30° C. The gelling temperature is above 85° C.

Hydrocolloids variety #3: has a size ranging from 2 to 20 µm and has a viscosity of 10 MPas at 1% weight at 80° C. The gelling temperature is 80° C. and above.

### Test

### One. Preparations Plant-Based Meatballs Sample

Prepare 3 basic meatballs with the same ingredients without the fat and water. Divide into three groups.
1. Soak textured vegetable protein (TVP) in water.
2. Then mix the soaked TVP and other dry ingredients (such as gluten, starch, seasoning) into a paste and divide into three groups.
3. Add nanoemulsion (300 nm - 320 nm) to the first group; add oil and water with the same proportion as the nanoemulsion to the second group; and add nanoemulsion (1 µm - 2 µm) to the third group.
4. Shape the mixture of each group into round meatballs.
5. Heat the meatballs to solidify, then store in the refrigerator.

### Two. Method of Testing Flavor Leachability of Plant-Based Meatballs

For the experiment, the plant-based meatballs (60 g) are boiled from frozen with water (600 mL), the three groups are in 3 different pots. Then, 10 mL of water is taken out every 3 minutes. After the water sample cools down and reaches room temperature, the 1.) Salinity 2.) Brix% and 3.) pH are measured.

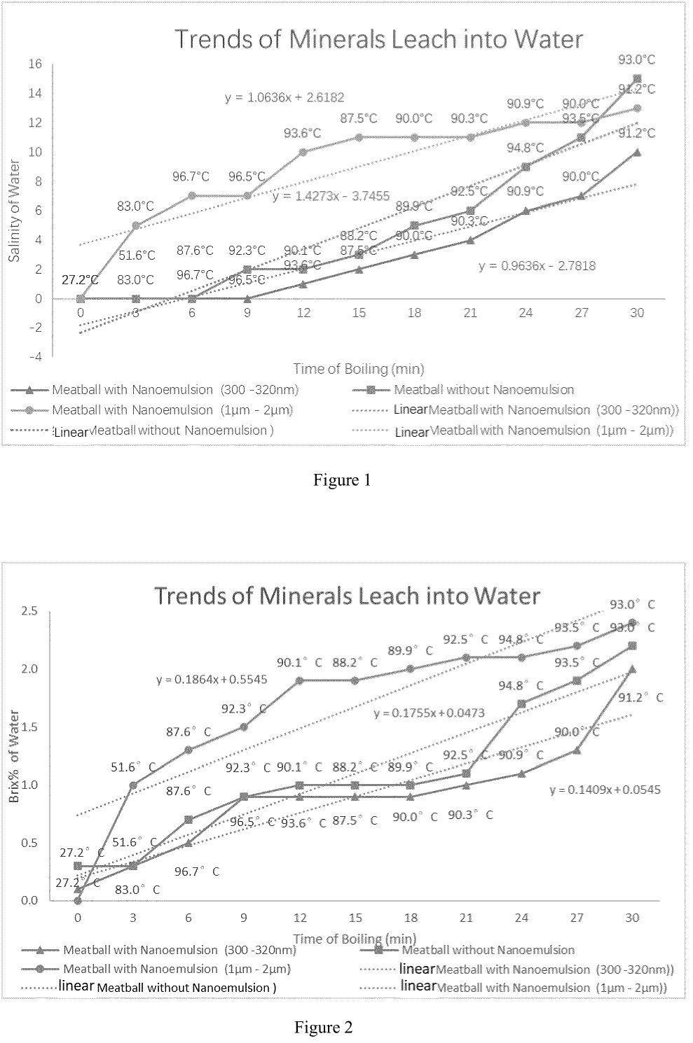

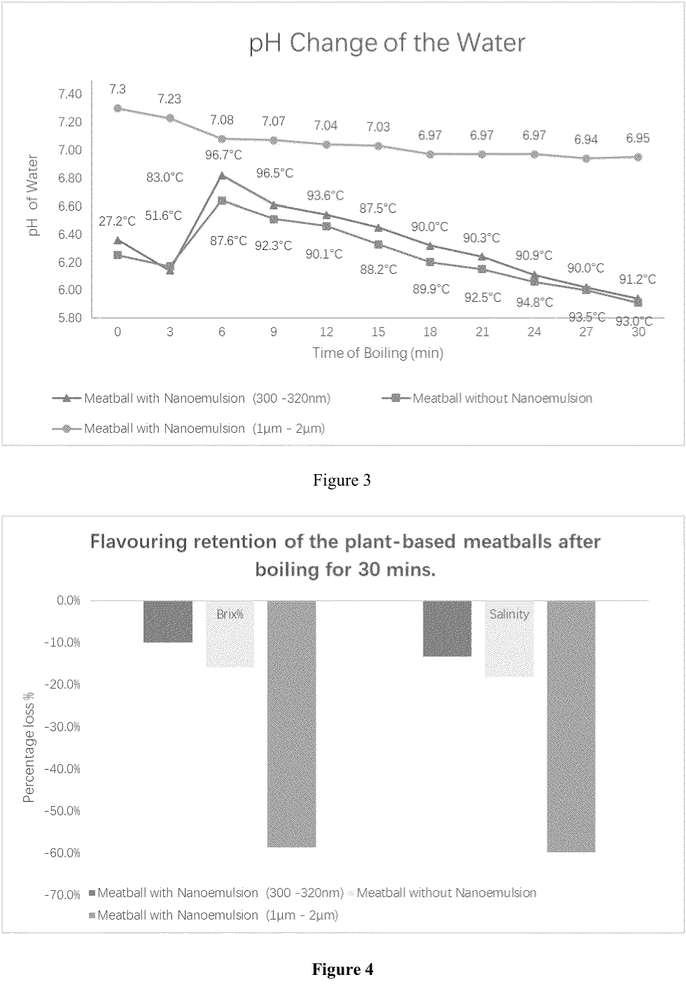

Results:
1. FIG. 1 shows the difference between the salinities’ change of boiling water at different temperatures within 30 minutes. The plant-based meatballs with nanoemulsion can retain salt better than the plant-based meatballs with no nanoemulsion.
2. FIG. 2 shows the difference in the Brix% change of boiling water at different temperatures within 30 minutes. The plant-based meatballs with nanoemulsion can retain sugar better than the plant-based meatballs with no nanoemulsion.
3. FIG. 3 shows the difference in the pH change of boiling water at different temperatures within 30 minutes. The pH changes of the plant-based meatballs with nanoemulsion are smaller than that of the plant-based meatballs with no nanoemulsion.

### Three. Method of Testing Flavor Retention of Plant-Based Meatballs

For the experiment, the plant-based meatballs (10 g) are blended with 50 g of water at 0 minute, and after 30 minutes boiling time with water.

Results:

Table 1 showed the percentage changes of Brix%, Salinity and pH values of the plant-based meatballs at the beginning and after 30 minutes of boiling. It can be seen that adding the nanoemulsion of the present invention can retain more sugar and salt, and the like.

Table 1

| | Meatballs with nanoemulsion(300-320 nm) | Meatballs without nanoemulsion | Meatballs with nanoemulsion(1 µm-2 µm) |
|---|---|---|---|
| Brix% | -10.0% | -15.8% | -58.7% |
| Salinity | -13.3% | -18.2% | -59.7% |
| pH | 0.00% | 0.83% | 0.00% |

FIG. 4 shows the percentage differences between the flavor retention in the samples plant-based meatball compared with the present and absence of nanoemulsion, there are 37% and 27% improvement respectively. And there are 83% and 78% flavor retention improvement in terms of brix% and salinity with different particle size.

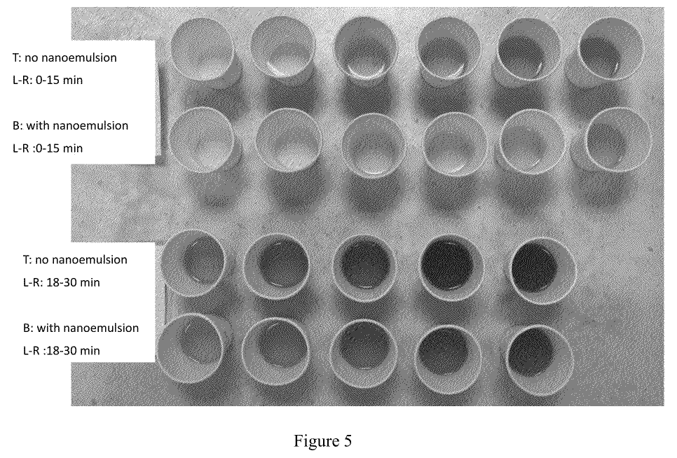

FIG. 5 also indicates that the addition of the nanoemulsion of the present invention can retain more substances in meatballs instead of dissolving in water.

Reference throughout this specification to “an embodiment”, “one embodiment”, “some embodiments”, “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments," “in one embodiment”, “in an embodiment”, “in another example, “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from the spirit, principles and scope of the present disclosure.

What is claimed is:

1. Nanoemulsion for preparing plant-based meat, wherein the nanoemulsion has a particle size ranging from 300 nm to 320 nm.

2. The nanoemulsion of claim 1, wherein the nanoemulsion is prepared through highpressure homogenization using oil and water in a certain proportion.

3. The nanoemulsion of claim 2, wherein the oil has a volume percentage ranging from 30% to 70%, and the water has a volume percentage ranging from 30% to 70%.

4. The nanoemulsion of claim 2, wherein the oil is a long-chain triglyceride.

5. The nanoemulsion of claim 2, wherein the oil is sunflower oil, canola oil, corn oil, soybean oil, macadamia oil, olive, safflower oil or a combination thereof.

6. Plant-based meat, wherein the plant-based meat is prepared by mixing the nanoemulsion according to claim 1 with dry particles, wherein the dry particles include plant-based protein, non-starch polysaccharides and hydrocolloids, and wherein the plant-based protein has a particle size ranging from 90 µm to 230 µm, the hydrocolloid has a particle size ranging from 2 µm to 150 µm.

7. The plant-based meat of claim 6, wherein the plant-based protein is prepared from soybeans, peas, mung beans or broad beans; wherein the non-starch polysaccharide is inulin, cellulose, pectin or glucan; and wherein the hydrocolloids is xanthan gum, carrageenan, guar gum, locust bean gum or konjac.

8. Plant-based meat, wherein the plant-based meat is prepared by mixing the nanoemulsion according to claim 2 with dry particles, wherein the dry particles include plant-based protein, non-starch polysaccharides and hydrocolloids, and wherein the plant-based protein has a particle size ranging from 90 µm to 230 µm, the hydrocolloid has a particle size ranging from 2 µm to 150 µm.

9. The plant-based meat of claim 8, wherein the plant-based protein is prepared from soybeans, peas, mung beans or broad beans; wherein the non-starch polysaccharide is inulin, cellulose, pectin or glucan; and wherein the hydrocolloids is xanthan gum, carrageenan, guar gum, locust bean gum or konjac.

10. Plant-based meat, wherein the plant-based meat is prepared by mixing the nanoemulsion according to claim 3 with dry particles, wherein the dry particles include plant-based protein, non-starch polysaccharides and hydrocolloids, and wherein the plant-based protein has a particle size ranging from 90 µm to 230 µm, the hydrocolloid has a particle size ranging from 2 µm to 150 µm.

11. The plant-based meat of claim 10, wherein the plant-based protein is prepared from soybeans, peas, mung beans or broad beans; wherein the non-starch polysaccharide is inulin, cellulose, pectin or glucan; and wherein the hydrocolloids is xanthan gum, carrageenan, guar gum, locust bean gum or konjac.

12. Plant-based meat, wherein the plant-based meat is prepared by mixing the nanoemulsion according to claim 4 with dry particles, wherein the dry particles include plant-based protein, non-starch polysaccharides and hydrocolloids, and wherein the plant-based protein has a particle size ranging from 90 µm to 230 µm, the hydrocolloid has a particle size ranging from 2 µm to 150 µm.

13. The plant-based meat of claim 12, wherein the plant-based protein is prepared from soybeans, peas, mung beans or broad beans; wherein the non-starch polysaccharide is inulin, cellulose, pectin or glucan; and wherein the hydrocolloids is xanthan gum, carrageenan, guar gum, locust bean gum or konjac.

14. Plant-based meat, wherein the plant-based meat is prepared by mixing the nanoemulsion according to claim 5 with dry particles, wherein the dry particles include plant-based protein, non-starch polysaccharides and hydrocolloids, and wherein the plant-based protein has a particle size ranging from 90 µm to 230 µm, the hydrocolloid has a particle size ranging from 2 µm to 150 µm.

15. The plant-based meat of claim 14, wherein the plant-based protein is prepared from soybeans, peas, mung beans or broad beans; wherein the non-starch polysaccharide is inulin, cellulose, pectin or glucan; and wherein the hydrocolloids is xanthan gum, carrageenan, guar gum, locust bean gum or konjac.

16. A method of preparing the plant-based meat of claim 6, comprising the following steps:
(1) mix the nanoemulsion from claim 1 with dry particles;
(2) refrigerate the mixture from step (1) for at least one hour and obtain the plant-based meat.

17. A method of preparing the plant-based meat of claim 7, comprising the following steps:
a) mix the nanoemulsion from claim 1 with dry particles;
b) refrigerate the mixture from step (1) for at least one hour and obtain the plant-based meat.

18. Use of the nanoemulsion of claim 1 in preparing the plant-based meat.
